(19) United States
(12) Patent Application Publication
(10) Pub. No.: US 2026/0266689 A1
(43) Pub. Date: Sep. 10, 2026

(54) METHOD AND SYSTEM FOR CONTROLLED INDUCEMENT IN VEHICLE COMPONENT

(71) Applicant: Ford Global Technologies, LLC, Dearborn, MI (US)

(72) Inventors: Amirhassan Abbasi, Farmington, MI (US); Arianna Duraku, Shelby Township, MI (US); Karen Willard, Grosse Pointe Farms, MI (US); Timothy Koepke, Dundee, MI (US); Satheesh Kumar Chandran, Livonia, MI (US); Vicky Svidenko, Newcastle, WA (US)

(73) Assignee: Ford Global Technologies, LLC, Dearborn, MI (US)

(21) Appl. No.: 19/073,562

(22) Filed: Mar. 7, 2025

(51) Int. Cl. G01M 13/045

(52) U.S. Cl. CPC G01M 13/045

(57) ABSTRACT

A method includes determining a baseline value of a first vehicle component at a set of operating conditions, applying a predetermined load to a second vehicle component to induce a design characteristic in the second vehicle component, determining an operational value of the second vehicle component at the set of operating conditions after the predetermined load is applied, and determining a deviation between the baseline value of the first vehicle component and the operational value of the second vehicle component.

### FIELD

The present disclosure relates to a method and system for controlled and accelerated inducement in a vehicle component.

### BACKGROUND

The statements in this section merely provide background information related to the present disclosure and may not constitute prior art.

Vehicle component samples (e.g., wheel bearing samples) may be obtained for the development of diagnostic and prognostic models. Developing models require access to a sufficient number of samples for each mode. These samples must also be representative of field components and follow predetermined patterns. Conventional inducement systems that induce a design characteristic in the samples may include testing the vehicle over long test runs, which will be time consuming and make repeatability a challenge.

These issues related to inducement systems for components, among other issues, are addressed by the present disclosure.

### SUMMARY

This section provides a general summary of the disclosure and is not a comprehensive disclosure of its full scope or all of its features.

In one form, the present disclosure provides a method that includes determining a baseline value of a first vehicle component at a set of operating conditions, applying a predetermined load to a second vehicle component to induce a design characteristic in the second vehicle component, determining an operational value of the second vehicle component at the set of operating conditions after the predetermined load is applied, and determining a deviation and an health indicator such as vibration amplitude between the baseline value of the first vehicle component and the operational value of the second vehicle component.

In variations of the method of the above paragraph, which can be implemented individually or in any combination: generating operational ranges based on the deviation between the baseline value (e.g., health indicator of first vehicle component) of the first vehicle component and the operational value (e.g., health indicator of second vehicle component) of the second vehicle component; applying the predetermined load to the second vehicle component comprises securing the second vehicle component to a test fixture, and applying the predetermined load to the second vehicle component after it is secured to the test fixture; the baseline value (e.g., health indicator) is a vibration value of the first vehicle component and the operational value (e.g., health indicator) is a vibration value of the second vehicle component; the predetermined load is applied using a hydraulic press; the set of operating conditions comprises a predetermined speed and another predetermined load; the predetermined load is a combination of a lateral load and a radial load to the second vehicle component; the first vehicle component and the second vehicle component are vehicle bearings; and the first vehicle component does not include an induced design characteristic.

In another form, the present disclosure provides a method that includes applying a first predetermined load to a first vehicle component to induce a design characteristic in the first vehicle component, determining an operational value (e.g., health indicator) of the first vehicle component at a set of operating conditions after the first predetermined load is applied, determining a deviation between a baseline value (e.g., health indicator) of a second vehicle component and the operational value of the first vehicle component, generating a plurality of operational ranges based on the deviation between the baseline value and the operational value, and applying a second predetermined load to a third vehicle component to induce another design characteristic in the third vehicle component based on a selected operational range of the plurality of operational ranges.

In variations of the method of the above paragraph, which can be implemented individually or in any combination: the set of operating conditions comprises a predetermined speed and another predetermined load; the first predetermined load is different from the second predetermined load; the baseline value is a vibration value of the second vehicle component and the operational value is a vibration value of the first vehicle component; the first and second predetermined loads are applied using a hydraulic press; applying the first predetermined load to the first vehicle component comprises securing the first vehicle component to a test fixture, and applying the first predetermined load to the first vehicle component after it is secured to the test fixture; each of the first and second predetermined loads is a combination of a lateral load and a radial load; and applying the second predetermined load to the third vehicle component comprises securing the third vehicle component to a test fixture, and applying the second predetermined load to the third vehicle component after it is secured to the test fixture.

In another form, the present disclosure provides a system that includes a load applicator, a plurality of sensors, and a controller. The sensors are configured to measure operating conditions of a plurality of vehicle components. The controller is in communication with the sensors and the load applicator. The controller is configured to: instruct the load applicator to apply a predetermined load to a first vehicle component of the plurality of vehicle component to induce a design characteristic in the first vehicle component, determine an operational value of the first vehicle component at a set of operating conditions after the predetermined load is applied, and determine a deviation between a baseline value of a second vehicle component of the plurality of vehicle components and the operational value of the first operating condition.

In variations of the system of the above paragraph, which can be implemented individually or in any combination: the controller is further configured to generate operational ranges based on the deviation between the baseline value of the second vehicle component and the operational value of the first operating condition and the operational value is a vibration value of the first vehicle component.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIG. 1A is a perspective view of a test fixture of a system for controlled inducement according to the principles of the present disclosure;

FIG. 1B is a schematic view of a test rig of the system for controlled inducement according to the principles of the present disclosure;

FIG. 2 is a block diagram showing components of the system of FIGS. 1A and 1B;

FIG. 3 is a flowchart depicting an algorithm of the system of FIGS. 1A and 1B for controlled inducement; and

FIG. 4 is a graphical representation of vibration test results for a number of samples using the system of FIGS. 1A and 1B.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

Conventional inducement systems may include testing the vehicle over long test runs, which make repeatability a challenge. The present disclosure provides a system and a method configured to quickly and conveniently induce design characteristic in vehicle components while maintaining control over the degree of design characteristic. In this way, there is no desire to test the entire vehicle over long test runs. Additionally, the system and method of the present disclosure provides consistent and repeatable design characteristic inducements by precisely controlling the applied loads to the vehicle components. In this way, more samples can be gathered for diagnostics and prognostics model development. Design characteristics can be nonconforming, unwanted induced characteristics to cause a premature end of life in the sample/component.

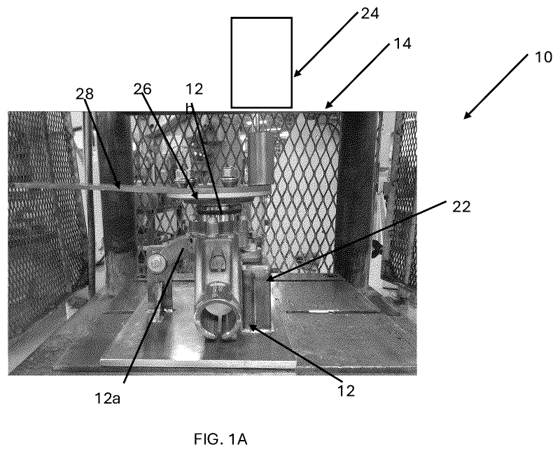

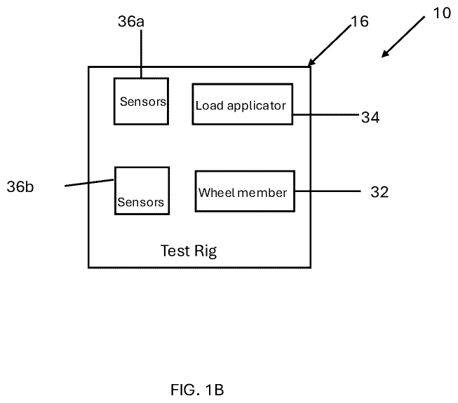

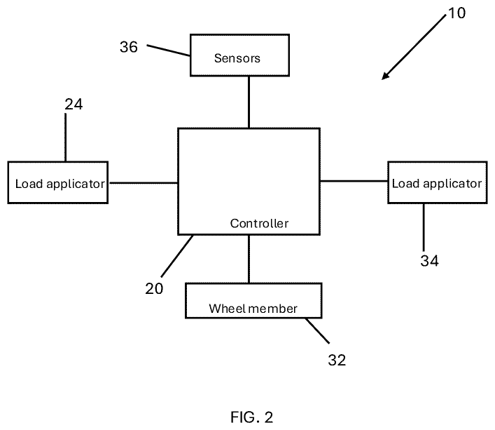

With reference to FIGS. 1A, 1B and 2, a system 10 for controlled inducement in vehicle components 12 is illustrated. Design characteristics may be induced in vehicle components and tested to obtain additional information regarding the vehicle component and its condition at various operating parameters. That is, the system 10 is configured to quickly induce a design characteristic into a vehicle component 12 based on a desired condition to be tested. In the example illustrated, the vehicle components 12 are wheel bearings of a vehicle. In some forms, the system 10 of the present disclosure may be used to induce a design characteristic in a controlled manner in other components of a vehicle or in other applications (e.g., bearings in machinery of an industrial environment).

The system 10 includes a test fixture 14 (FIG. 1A), a test rig or stand 16 (FIG. 1B), and a controller 20 (FIG. 2). The test fixture 14 is configured to quickly induce a design characteristic into a vehicle component 12 (wheel bearing 12b of the vehicle component 12) based on a desired condition to be tested. For example, the test fixture 14 may induce a design characteristic into the vehicle component 12 within 30 minutes or less without the vehicle component 12 having to be installed on a vehicle or taken apart (e.g., dismantling raceways of the wheel bearing). The test fixture 14 includes a base structure 22 and a load applicator 24. The base structure 22 is fixed to a surface and configured receive the vehicle component 12. In the example illustrated, the vehicle component 12 includes a spindle 12a (i.e., a knuckle) and the wheel bearing 12b mounted to the base structure 22. Stated differently, the wheel bearing 12b is mounted at least partially within the spindle 12a and the spindle 12a is secured to the base structure 22 of the test fixture 14. An optional reinforcement flange 26 may be secured to the wheel bearing 12b and an optional plate 28 may be secured (via mechanical fasteners) to the reinforcement flange 26.

The load applicator 24 moves between a first position (FIG. 1A) in which the load applicator 24 is spaced apart from the vehicle component 12 and a second position (not specifically shown) in which the load applicator 24 applies a predetermined load to the vehicle component 12 as will be described in greater detail below. The predetermined load applied to the vehicle component 12 by the load applicator 24 is configured to induce a design characteristic into the wheel bearing 12b of the vehicle component 12. In one form, the load applicator 24 may be a press such as a hydraulic press that is allowed to apply a load (e.g., 25 tons) to the vehicle component 12. In some forms, the load may be applied to a lateral face of the wheel bearing 12b. In the forms where the test fixture 14 includes the optional reinforcement 26 and the optional plate 28, the load may be applied to an edge of the reinforcement flange 26 or an edge of the plate 28. In this way, the design characteristic induced on the wheel bearing 12b may simulate a Brinell characteristic (i.e., specific impact moment load on wheel bearings which produces indentations or dents on the raceway of the wheel bearings). The moment load on the wheel bearings may have a radial load and/or a lateral load.

With reference to FIG. 1B, the test rig 16 is configured to measure an operational value of a respective vehicle component 12 at a predetermined set of operating conditions. The set of operating conditions (e.g., speed of the vehicle component, force applied to the vehicle component, etc.) are configured to simulate the vehicle component 12 being on a vehicle out on the road and experiencing a specific impact event. The test rig 16 includes, inter alia, a wheel member 32, a load applicator 34, and a plurality of sensors 36a, 36b (together referred to as sensors 36). The wheel member 32 is configured to be connected to the vehicle component 12 and is configured to rotate the vehicle component 12 at a predetermined speed, for example. In one form, the wheel member 32 is configured to rotate the vehicle component 12 at 800 revolutions per minute (rpm). In another form, the wheel member 32 is configured to rotate the vehicle component 12 at 500 revolutions per minute (rpm). In yet another form, the wheel member 32 is configured to rotate the vehicle component at 200 revolutions per minute (rpm).

The load applicator 34 moves between a first position in which the load applicator 34 is spaced apart from the vehicle component 12 and a second position in which the load applicator 34 applies a predetermined load to the vehicle component 12. The predetermined load applied to the vehicle component 12 by the load applicator 34 is configured to simulate the vehicle component 12 experiencing a force on a road, for example, such as during a specific impact event. In one form, the load applicator 34 may be a press such as a hydraulic press that is allowed to apply a load (e.g., 25 tons) to the vehicle component 12. The load applied by the load applicator 34 on the vehicle component 12 may have a radial component and/or a lateral component. For example, the load applicator 34 may be apply a load to the vehicle component 12 that includes both a radial load and a lateral load. In another example, the load applicator 34 may apply a load to the vehicle component 12 that includes only one of a radial load and a lateral load. The load applied to the vehicle component 12 may be held for a predetermined time period (e.g., 30 minutes).

The sensors 36a may be associated with the test rig 16 and may be configured to measure an operational value indicative of vibration of the wheel bearing 12b on the test rig 16. For example, the sensors 36a may be an accelerometer that measures the acceleration of the wheel bearing 12b. The sensors 36b may be associated with the test rig 16 and may be configured to measure an operational value indicative of noise/vibration levels of the wheel bearing 12b on the test rig 16. For example, the sensors 36b may be acoustic/vibration sensors, for example, that measure acoustic/vibration levels of the vehicle component 12 while rotating on the wheel member 32.

In one form, the vehicle component 12 may undergo the set of predetermined operating conditions for a predetermined time period. For example, the vehicle component 12 may undergo one or more of the operating conditions above for 30 minutes. In another example, the vehicle component 12 may undergo one or more of the operating conditions above for 10 minutes. In yet another example, the vehicle component 12 may undergo one or more of the operating conditions above for 60 minutes. The test rig 16 may include additional components to further simulate conditions of the road including fans/heating elements to simulate temperature as well as other operating conditions of the vehicle and/or vehicle component 12. For example, the vehicle component 12 may be secured to the wheel member 32 at a predetermined torque to simulate wheels of a vehicle being torque to a predetermined value.

With reference to FIG. 2, the controller 20 is in communication with the load applicators 24, 34, the sensors 36a, 36b, and the wheel member 32, and may monitor conditions of the sensors 36a, 36b and control operations of the load applicators 24, 34 and the wheel member 32. The controller 20 may determine an operational value indicative of vibration of one or more induced vehicle components 12 at a set of operating conditions, may determine a deviation between a baseline value (e.g., health indicator) of a vehicle component 12 and the operational value of an induced vehicle component 12, and may generate operational ranges based on the determined deviation.

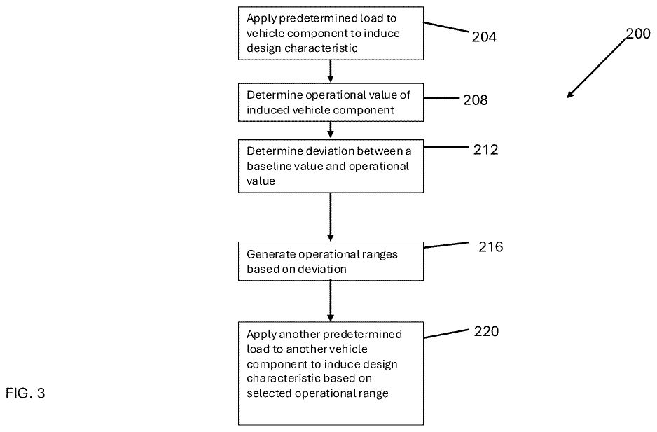

With reference to FIG. 3, an example control algorithm 200 for processing one or more vehicle components 12 by the system 10 is illustrated. The processing may begin once one or more wheel bearings without an induced design characteristics are coupled to the test rig 16 for testing. That is, the test rig 16 may test these wheel bearings to obtain operational values (vibration results) of wheel bearings without an induced design characteristic. In this way, baseline values of one or more wheel bearings may be obtained as a benchmark to compare against design characteristic induced wheel bearings. The baseline values of the wheel bearings without induced design characteristics may also be used to develop an acceptable range of vibration results to be used later in diagnostic and/or prognostic model development. In one form, the wheel bearings without induced design characteristics may be different type of wheel bearings for the same application.

At 204, the control algorithm, using the controller 20, instructs the load applicator 24 to apply a predetermined load to a vehicle component 12 to induce a design characteristic in the vehicle component 12. That is, the vehicle component 12 is secured to the test fixture 14 as described above and the load applicator 24 moves from the first position to the second position to apply the predetermined load to the vehicle component 12 to induce the design characteristic in the vehicle component 12. In one form, the predetermined load applied to the vehicle component 12 may be such to induce a higher degree of design characteristic to the vehicle component 12 without causing the vehicle component 12 to fracture.

At 208, the control algorithm, using the controller 20, determines an operational value (e.g., vibrational value) of the induced vehicle component 12 at a set of operating conditions after the predetermined load at step 204 is applied. That is, the induced vehicle component 12 is secured to the test rig 16 as described above while the load applicator 34 applies a load to the induced vehicle component 12 and the wheel member 32 rotates the induced vehicle component 12. The sensors 36a measure acceleration of the design characteristic induced vehicle component 12 and the controller 20 determines the operational value (e.g., vibration value) from the measured acceleration. In this way, the operational value of the induced vehicle component 12 is determined while the induced vehicle component 12 undergoes a simulation of being on a vehicle on the road, for example. It should also be understood that noise/vibration levels in the wheel bearing 12b may be determined using the sensors 36b and further correlated to design characteristics in the wheel bearing 12b.

At 212, the control algorithm, using the controller 20, determines a deviation between the baseline value(s) of the wheel bearings without induced design characteristic and the operational value of the induced wheel bearing 12b of the vehicle component 12. For example, if the vibration value of the induced wheel bearing 12b is 0.6 g and the vibration value of the baseline value of the wheel bearing without an induced design characteristic is 0.2 g, then the deviation is taken by the different between 0.6 g and 0.2 g. It should be understood that the deviation confirms that the induced on the vehicle component 12 at the test fixture 14 was successful.

At 216, the control algorithm, using the controller 20, generates operational ranges based on the deviation between the baseline value of the wheel bearing without an induced design characteristic and the operational value of the induced wheel bearing 12b of the vehicle component 12. In this way, the deviation may be separated out into ranges to further classify or group the degree of design characteristic in the vehicle components. For example, a range of 0-0.2 g may be considered acceptable in the wheel bearing, a range of 0.2 g-0.4 g may be considered low level of induced design characteristic, a range of 0.4 g-0.6 g may be considered moderate level of induced design characteristic, and a range of 0.6 g and above may be considered high level of induced design characteristic.

At 220, the control algorithm, using the controller 20, instructs the load applicator 24 to apply another predetermined load to another vehicle component 12 to induce a design characteristic in the vehicle component 12 based on a selected operational range of the plurality of operational ranges. That is, if it is determined that testing of a vehicle component 12 in the low level of or moderate level of induced design characteristic is desired based on the generated operational ranges at step 216, the vehicle component 12 is secured to the test fixture 14 as described above and the load applicator 24 applies a predetermined load to induce a design characteristic in the vehicle component 12 in the desired range to be tested. That is, the predetermined load applied to the vehicle component 12 may be less than the induced design characteristic at the vehicle component at step 204. In this way, the system 10 may quickly and conveniently induce design characteristic in vehicle components 12 such that the induced vehicle components can be tested having a desired or selected degree of health.

This process can be repeated for a plurality of vehicle components 12 whereby the vehicle components 12 desire testing at preselected health levels. That is, different loads may be applied using the load applicator 24 to a plurality of vehicle components 12. The system 10 provides the benefit of quantifying the health level in the vehicle component 12 and accurately and quickly labeling such induced vehicle component. The system 10 also provides the benefit of using the data gathered for prognostic and diagnostic model development.

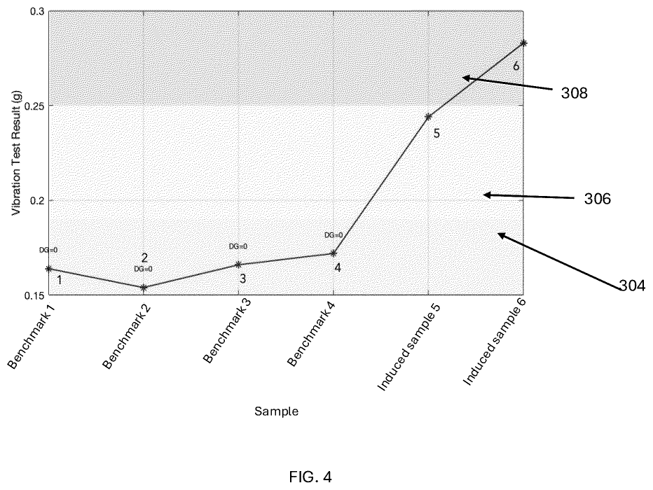

With reference to FIG. 4, a graphical representation of vibration test results is shown for a number of samples using the system 10 described above. That is, bearings without induced design characteristics (benchmarks) were tested using the test rig 16 and plotted on the graph as baseline or benchmark values (see data points 1-4). These bearings can be bearings of a north American type (application) of European type (application). Next, a high-level degree of design characteristic was induced on a wheel bearing using the test fixture 14 and an operational value was determined using the test rig 16 and controller 20. That is, the induced design characteristic on the wheel bearing may be a Brinelled Roush design characteristic. This data point is shown in FIG. 5 as sample 6. The deviation was determined based on sample 6 and the benchmark samples 1-4, and ranges were determined to further quantify the degree of inducement on further samples. That is, section 304 (vibration levels between 0.15 g-0.17 g) of the graph shows acceptable ranges, section 306 (vibration levels between 0.17 g-0.25 g) of the graph shows a moderate level of inducement and section 308 (0.25 g-0.3 g) of the graph shows a high level of inducement. This allows additional induced wheel bearings to be tested based on a desired degree of health. For example, one wheel bearing was tested and plotted on the graph as sample 4, which has a moderate level of inducement. The additional induced wheel bearings may also be Brinelled Roush design characteristic.

Unless otherwise expressly indicated herein, all numerical values indicating mechanical/thermal properties, compositional percentages, dimensions and/or tolerances, or other characteristics are to be understood as modified by the word “about” or “approximately” in describing the scope of the present disclosure. This modification is desired for various reasons including industrial practice, material, manufacturing, and assembly tolerances, and testing capability.

As used herein, the phrase at least one of A, B, and C should be construed to mean a logical (A OR B OR C), using a non-exclusive logical OR, and should not be construed to mean “at least one of A, at least one of B, and at least one of C.”

In this application, the term “controller” and/or “module” may refer to, be part of, or include: an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor circuit (shared, dedicated, or group) that executes code; a memory circuit (shared, dedicated, or group) that stores code executed by the processor circuit; other suitable hardware components that provide the described functionality; or a combination of some or all of the above, such as in a system-on-chip.

The term memory is a subset of the term computer-readable medium. The term computer-readable medium, as used herein, does not encompass transitory electrical or electromagnetic signals propagating through a medium (such as on a carrier wave); the term computer-readable medium may therefore be considered tangible and non-transitory. Non-limiting examples of a non-transitory, tangible computer-readable medium are nonvolatile memory circuits (such as a flash memory circuit, an erasable programmable read-only memory circuit, or a mask read-only circuit), volatile memory circuits (such as a static random access memory circuit or a dynamic random access memory circuit), magnetic storage media (such as an analog or digital magnetic tape or a hard disk drive), and optical storage media (such as a CD, a DVD, or a Blu-ray Disc).

The apparatuses and methods described in this application may be partially or fully implemented by a special purpose computer created by configuring a general-purpose computer to execute one or more particular functions embodied in computer programs. The functional blocks, flowchart components, and other elements described above serve as software specifications, which can be translated into the computer programs by the routine work of a skilled technician or programmer.

The description of the disclosure is merely exemplary in nature and, thus, variations that do not depart from the substance of the disclosure are intended to be within the scope of the disclosure. Such variations are not to be regarded as a departure from the spirit and scope of the disclosure.

What is claimed is:

1. A method for controlled and accelerated inducement, the method comprising:
determining a baseline value of a first vehicle component at a set of operating conditions;
applying a predetermined load to a second vehicle component to induce a design characteristic in the second vehicle component;
determining an operational value of the second vehicle component at the set of operating conditions after the predetermined load is applied; and
determining a deviation between the baseline value of the first vehicle component and the operational value of the second vehicle component.

2. The method of claim 1, further comprising generating operational ranges based on the deviation between the baseline value of the first vehicle component and the operational value of the second vehicle component.

3. The method of claim 1, wherein applying the predetermined load to the second vehicle component comprises securing the second vehicle component to a test fixture, and applying the predetermined load to the second vehicle component after it is secured to the test fixture.

4. The method of claim 1, wherein the baseline value is a vibration value of the first vehicle component and the operational value is a vibration value of the second vehicle component.

5. The method of claim 1, wherein the predetermined load is applied using a hydraulic press.

6. The method of claim 1, wherein the set of operating conditions comprises rotating each of the first and second vehicle components at a predetermined speed and applying another predetermined load to each of the first and second vehicle components.

7. The method of claim 1, wherein the predetermined load is a combination of a lateral load and a radial load to the second vehicle component.

8. The method of claim 1, wherein the first vehicle component and the second vehicle component are vehicle bearings.

9. The method of claim 1, wherein the first vehicle component does not include an induced design characteristic.

10. A method for controlled and accelerated inducement, the method comprising:
applying a first predetermined load to a first vehicle component to induce a design characteristic in the first vehicle component;
determining an operational value of the first vehicle component at a set of operating conditions after the first predetermined load is applied;
determining a deviation between a baseline value of a second vehicle component and the operational value of the first vehicle component;
generating a plurality of operational ranges based on the deviation between the baseline value and the operational value; and
applying a second predetermined load to a third vehicle component to induce another design characteristic in the third vehicle component based on a selected operational range of the plurality of operational ranges.

11. The method of claim 10, wherein the set of operating conditions comprises rotating the first vehicle component at a predetermined speed and applying another predetermined load to the first vehicle component.

12. The method of claim 10, wherein the first predetermined load is different from the second predetermined load.

13. The method of claim 10, wherein the baseline value is a vibration value of the second vehicle component and the operational value is a vibration value of the first vehicle component.

14. The method of claim 10, wherein the first and second predetermined loads are applied using a hydraulic press.

15. The method of claim 10, wherein applying the first predetermined load to the first vehicle component comprises securing the first vehicle component to a test fixture, and applying the first predetermined load to the first vehicle component after it is secured to the test fixture.

16. The method of claim 10, wherein each of the first and second predetermined loads is a combination of a lateral load and a radial load.

17. The method of claim 10, wherein applying the second predetermined load to the third vehicle component comprises securing the third vehicle component to a test fixture, and applying the second predetermined load to the third vehicle component after it is secured to the test fixture.

18. A system for controlled and accelerated inducement, the system comprising:
a load applicator;
a plurality of sensors configured to measure operating conditions of a plurality of vehicle components; and
a controller in communication with the sensors and the load applicator, the controller configured to:
instruct the load applicator to apply a predetermined load to a first vehicle component of the plurality of vehicle component to induce a design characteristic in the first vehicle component;
determine an operational value of the first vehicle component at a set of operating conditions after the predetermined load is applied; and
determine a deviation between a baseline value of a second vehicle component of the plurality of vehicle components and the operational value of the first operating condition.

19. The system of claim 18, further comprising generating operational ranges based on the deviation between the baseline value of the second vehicle component and the operational value of the first operating condition.

20. The system of claim 18, wherein the operational value is a vibration value of the first vehicle component.
